(19) United States
(12) Patent Application Publication
(10) Pub. No.: US 2025/0265405 A1
(43) Pub. Date: Aug. 21, 2025

(54) Locating Instances in a Layout

(71) Applicant: Taiwan Semiconductor Manufacturing Company, Ltd., Hsinchu (TW)

(72) Inventors: Liting Shen, Hsinchu (TW); Sung Ryul Kim, Hsinchu (TW); Zhe Zhang, Hsinchu (TW); Kuoyuan Hsu, Hsinchu (TW)

(21) Appl. No.: 18/755,889

(22) Filed: Jun. 27, 2024

Related U.S. Application Data
(60) Provisional application No. 63/555,435, filed on Feb. 20, 2024.

(51) Int. Cl. G06F 30/392; G06F 30/31

(52) U.S. Cl. CPC G06F 30/392; G06F 30/31

(57) ABSTRACT

Systems and methods for finding instances in a circuit layout are described. A method of finding instances comprises assigning an initial name and an initial position to a tracking cell in a bottom instance of a plurality of instances determining whether the initial name corresponds to a name of a top instance of the plurality of instances, determining a position parameter and a number information for converting the initial name and the initial position in the bottom instance to another instance greater than the bottom instance, and reporting the position of the instance greater than the bottom instance to a user, via a graphical user interface (GUI). An integrated circuit is fabricated based on the circuit layout.

### CROSS-REFERENCE TO RELATED APPLICATIONS

This application claims priority to U.S. Provisional Application No. 63/555,435, filed Feb. 20, 2024, entitled “Locating Instances in GDS Layouts,” which is incorporated herein by reference in its entirety.

### BACKGROUND

In certain integrated circuits, such as memory structures, tracking cells play a role in ensuring proper functioning of a memory array. In some examples, tracking cells are implemented as a means to track signal transmission and timing through memory cells to ensure the proper operation of a memory array. These tracking cells may be generated during a design stage in order to track signal transmission through a circuit or device and confirm that the memory array can be operated successfully. On account of this importance, design verification may include checking a design for the presence of tracking cells, which may increase the time needed to perform design verification.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram depicting a layout of an integrated circuit according to an embodiment.

FIG. 2 is conceptual diagram depicting a layout hierarchy according to an embodiment.

FIGS. 3A, 3B, and 3C are block diagrams depicting example systems for implementing approaches described herein for designing integrated circuits, according to an embodiment.

FIGS. 4A and 4B are a flowchart depicting a method of finding instances in a layout according to an embodiment and a flowchart depicting a method of designing and fabricating an circuit, according to an embodiment.

FIG. 5 is a conceptual diagram depicting a textual representation of circuit data according to an embodiment.

FIGS. 6A and 6B are conceptual diagrams depicting example results of a method of finding instances in a circuit diagram according to an embodiment.

FIG. 7 is a conceptual diagram depicting a layout hierarchy according to an embodiment.

FIG. 8 is a conceptual diagram depicting number information represented as a 2D array according to an embodiment.

FIG. 9 is a conceptual diagram depicting number information represented as a 3D network according to an embodiment.

FIG. 10 is a flowchart depicting a method of finding instances in a circuit design according to an embodiment.

FIG. 11 is a conceptual diagram depicting number information according to an embodiment.

FIG. 12 is a schematic diagram depicting a method of finding instances using number information according to an embodiment.

FIG. 13 is a conceptual diagram depicting example results of a method of finding instances in a circuit diagram according to an embodiment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in some various examples. This repetition is for the purpose of simplicity and clarity and does not in itself dictate a relationship between some various embodiments and/or configurations discussed.

As described above, certain memory circuits, devices, and systems, such as static random access memory (SRAM), may incorporate tracking cells in order to track signal transmission and confirm that the design can be operated successfully. More specifically, in the design of an SRAM compiler, tracking cells may ensure proper functioning of an SRAM macros generated form an SRAM design by tracking signal transmission and confirming successful operation. Due to this important functionality, a verification process may entail checking for the location and quantity of tracking cells in the design.

However, manually searching for the location and quantity of these tracking cells among hundreds of macros may be a time and resource consuming practice. Such a manual search process may be impractical and can result in an undesirable reduction in checking coverage. To address this challenge, embodiments described herein implement an automated program that may quickly and accurately identify all tracking cells within a given SRAM macros.

The automated program may utilize number information, such as the number of instances of tracking cells on each level of a layout hierarchy, in order to quickly and accurately identify all tracking cells within the macros. Using such number information while checking or verifying a layout may provide confirmation that all instances of tracking cells within the layout are located. Accordingly, embodiments described herein may improve checking efficiency by reducing checking time, increasing accuracy, and enabling up to 100% checking coverage.

According to embodiments described herein, number checking efficiency may be increased by using number information of a layout structure to find all instances of a particular cell or structure, such as an individual tracking cell or group of tracking cells. Even more, the use of number information of a layout structure may enable finding all small instances within the layout. The number information may be rendered as a 2D array or take the format of a 3D network. Additionally, embodiments described herein may process gdt files rather than gds files. Gdt files may represent text versions of a gds file, making them smaller and size and faster to process. In some embodiments, a specialized library may be used to extract useful information from the gdt files. For example, embodiments may use regexes of the Perl language to perform such information extraction. This information may be used in the process of identifying instances throughout a layout design. Accordingly, embodiments described herein may provide an efficient and accurate means for searching for particular instances or structures within an integrated circuit design.

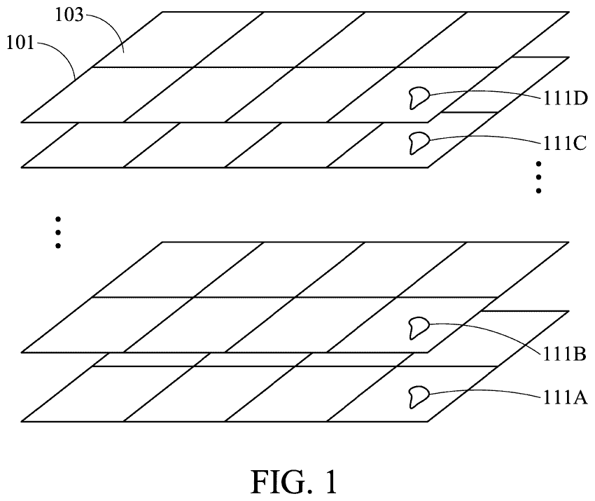

FIG. 1 is a conceptual diagram depicting a layout of an integrated circuit according to an embodiment. An integrated circuit may comprise a stacked structure comprising a plurality of layers. The stacked structure may comprise a plurality of levels, with each level corresponding to a layer of an integrated circuit comprising devices, routing, or any other circuit or semiconductor components. The plurality of layers of the integrated circuit may comprise a plurality of memory arrays, or macros, 101 and these layers may be stacked to form the stacked or 3D structure. In an embodiment, the stacked layers may comprise memory macros 101. Each memory macro 101 may comprise a plurality of segments 103, each serving one or more particular functions for the memory structure.

In an embodiment, memory segments 103 may comprise memory banks, local input/output circuits (LIO), global input/output circuits (GIO), decoder regions, local control regions (LCTRL), and global control regions (GCTRL). However, embodiments described herein are not so limited and memory segments 103 may comprise any type of circuit or functional unit as decided by a circuit designer. The structure and design of memory segments 103 may be set according to fundamental building blocks called cells, that a circuit designer may use when designing an integrated circuit.

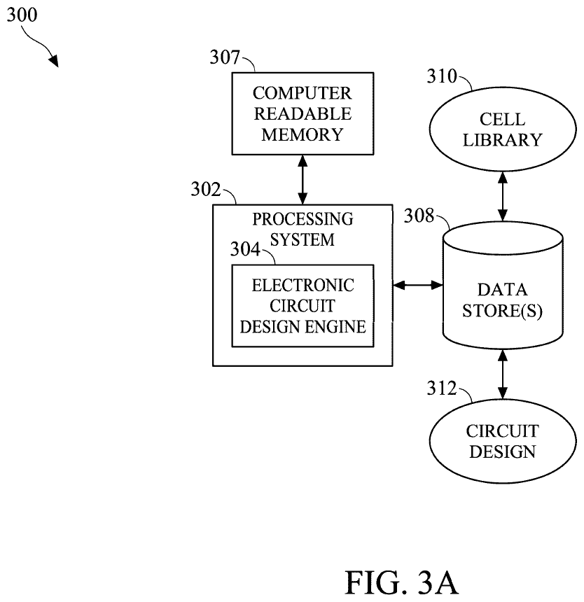

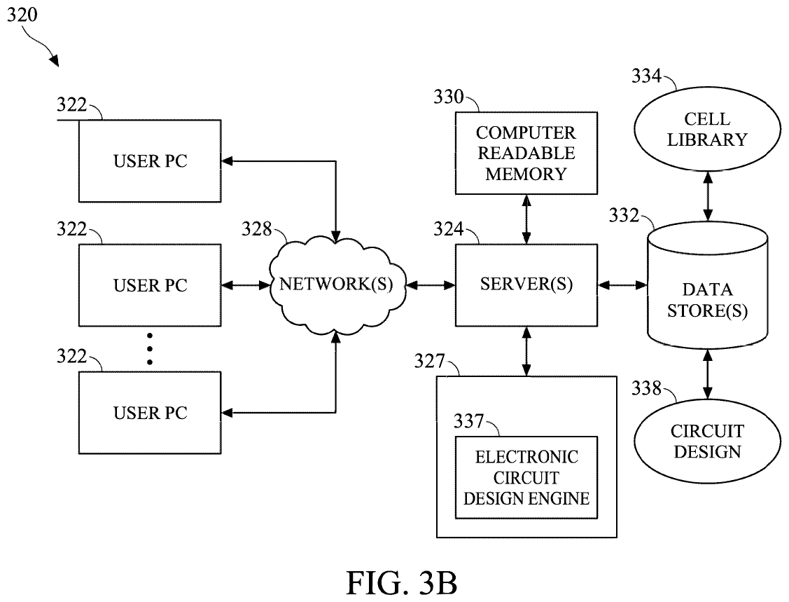

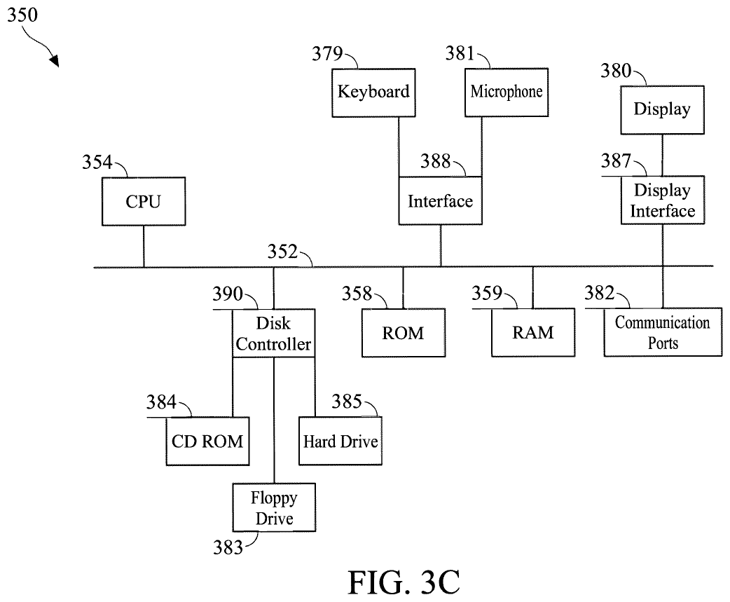

As described below in greater detail with respect to FIGS. 3A-3C, a circuit designer may use circuit design tools such as computer-aided design (CAD) tools or other electronic design automation (EDA) solutions to facilitate quick and accurate design. Cells used by designers may include pre-determined, standard architecture selected to provide specific logic or storage functions (e.g. AND gates, OR gates, XOR gates, NOT gates, NAND gates, NOR gates, XNOR gates, flip-flops, inverters, latches). In some cases, cell structures may be standardized and the design of these standardized cells may be stored in, and recalled from, a library, allowing designers to create complicated and densely packed integrated circuits with reduced time and effort.

For example, memory segments 103 may comprise one or more cells, providing a more uniform and predictable structure for each segment. In an embodiment, each macro 101 may similarly comprise a standard layout of memory segments 103, such that the stack of macros comprises a stack of substantially uniform layouts. However, designs and layouts described herein are not so limited and, in other embodiments, the layout of macros 101 on different levels may differ.

Before proceeding from a design stage to tapeout, circuit designs may undergo a verification process in order to ensure that the proposed design meets all desired specifications and design rules. As a part of this verification, a checking process may be performed to check the design for particular instances. For example, in FIG. 1, each memory macro 101 may comprise a similar instance represented by reference number 111. On a first layer, a first macro may comprise a first instance 111A. On a second layer, directly above the first layer, a second macro may comprise a second instance 111B. This pattern may repeat for all layers, including a penultimate level which may comprise a macro including a third instance 111C, and a top level, which may comprise a macro including a fourth instance 111D. Additionally, while not shown, multiple segments 103 within a same macro 101 may comprise similar instances.

Instances 111 may refer to specific portions of the layout occupied by a certain feature. Generally, a particular instance may be a small instance, such as a particular cell or group of cells, or other basic components of the layout, or a large instance such as a memory segment or macro. In an embodiment, instances 111 may comprise small instances formed within a memory segment 103.

During a checking process, as described above, it may be desirable to check a layout to obtain a location and number of a particular instance. For example, the plurality of macros 101 may comprise SRAM macros. Each SRAM macro may comprise one or more tracking cells to track signal transmission and confirm that the design can be operated successfully. Because of this function of such tracking cells in a generated SRAM, it may be desirable to check the layout for all instances of tracking cells to ensure there are a sufficient number of them and that they are in the correct locations. As such, instances 111A, 111B, 111C, and 111D may be instances comprising one or more tracking cells within the layout, and the process of designing and fabricating an integrated circuit based on this layout may comprise checking the layout for these instances.

SRAM macros 101 may contain thousands of cells, including a number of tracking cells and these tracking cells may be dispersed throughout an SRAM layout, in different layers and locations. As such, it may be difficult to manually locate these tracking cells and determining their positions within the layout may require time consuming manual steps. Systems and methods according to embodiments herein may provide an automated implementation of this process, allowing for one program to find all instances of tracking cells to be found. Doing so may improve the efficiency and accuracy of the search process.

For example, given a layout as described above with respect to FIG. 1, it may be desirable to check the layout for all instances 111 of a tracking cell. In some systems this may involve manually checking a layout using a manual search function or by moving a cursor through the layout to locate instances. Embodiments described herein may automate this process such that the whole layout may be checked and all instances of a tracking cell can be quickly and accurately located and accounted.

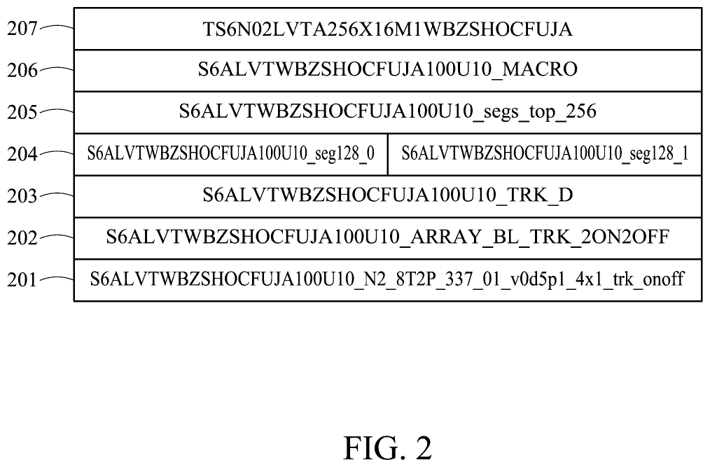

FIG. 2 is schematic diagram depicting a layout hierarchy according to an embodiment. The layout hierarchy may represent a way to conceptually breakdown a full integrated circuit design into components for ease of design and analysis. The hierarchy an individual macro. Below that, fifth level 205 may represent a particular group of segments. And this pattern continues such that first level 201 may represent a smallest building block of the circuit design, for example an individual cell, or an individual functional unit comprised of a small number of cells. Some levels may be divided into multiple sub-levels. For example, as shown in FIG. 2, fourth level 204 may be divided into a first sub-level 204A and a second sub-level 204B.

In an embodiment, there may be one or more instances comprising one or more a tracking cells in each level. The cell name of the tracking cell(s) in each level may be similar. The cell name may refer to a string of alphanumeric (or other) characters applied to a particular cell by a design tool. These names may be displayed to a user of the tool through a graphical user interface, allowing the user to identify a particular cell. For example, a cell in bottom level 201 may be named “S6ALVTWBZSHOCFUJA100U10_N2_8T2P_337_01_v0d5p1_4x1_trk_onoff.” In second level 202, the cell name may be similar, but different. For example, a tracking cell second level 202 may be “S6ALVTWBZSHOCFUJA100U10_ARRAY_BL_TRK_2ON2OFF.” Although these names are not identical, they comprise similar character strings, notably sharing a number of characters at the beginning of the name. Embodiments described herein may exploit this similarity in order to identify all instances from the name of a first instance.

In some embodiments, this naming convention may apply to all instances within the layout. However, in some cases a top level or higher level instance may not have a corresponding name. For example, as shown in FIG. 2, each of levels 1-6 comprise tracking cells have similar names. In particular, the tracking cells in each level may begin with a same string of characters. In top level 207, however, the tracking cell does not have this same naming convention. To account for this, in some embodiments, cell names may be converted in order to facilitate more efficient searching. The cell names may be converted from one level to the next according to information from a gdt file. Using this process, a position of a higher level instance may be inferred from a lower level instance. These processes, and systems enacting and embodiment the same, are described in greater detail below.

An example, this process may comprise assigning an initial name and an initial position to a tracking cell in a bottom instance of plurality of instances in a layout. For higher level instances, a determination may then be made as to whether the initial name corresponds to a name of a top instance of the plurality of instances. If the name corresponds, the initial position may be reported as an instance. If the name does not correspond, a process of converting the initial name and the initial position of the bottom instance to another instance greater than the bottom instance may occur.

In an embodiment, this process may comprise determining a position parameter and a number information used to implement the converting. The position parameter may, for example, comprise a flip operation, rotating operation, and/or a shifting operation. The number information may, for example, comprise an amount of tracking cells in each level of the layout hierarchy. The position parameter and number information may be used to infer the position and name of higher level instances. The inferred name may then be compared against the name of a top instance of the plurality of instances to see if they match. If not, the loop may continue so as to identify all instances within the layout. The loop may end when the inferred name matches the name of the top instance.

FIGS. 3A, 3B, and 3C are block diagrams depicting example systems for implementing approaches described herein for designing integrated circuits. These systems may represent circuit design tools that are capable of enacting the processes and functions described herein.

For example, FIG. 3A depicts an exemplary system 300 that includes a standalone computer architecture where a processing system 302 (e.g., one or more computer processors located in a given computer or in multiple computers that may be separate and distinct from one another) includes a computer-implemented electronic circuit design engine 304 being executed on the processing system 302. The processing system 302 has access to a computer-readable memory 307 in addition to one or more data stores 308. The one or more data stores 308 may include a cell library database 310 as well as a circuit design database 312. The processing system 302 may be a distributed parallel computing environment, which may be used to handle very large-scale data sets. Cell library database 310 and circuit design database 312 may enable automated checking of instances according to embodiments described herein. For example, cell library database 310 may contain designs or architectures for a tracking cell. Circuit design database 312 may store various programs or functions for enacting circuit design operations.

FIG. 3B depicts a system 320 that includes a client-server architecture. One or more user PCs 322 access one or more servers 324 running an electronic circuit design engine 337 on a processing system 327 via one or more networks 328. The one or more servers 324 may access a computer-readable memory 330 as well as one or more data stores 332. The one or more data stores 332 may include a cell library database 334 as well as a circuit design database 338.

FIG. 3C shows a block diagram of exemplary hardware for a standalone computer architecture 350, such as the architecture depicted in FIG. 3A that may be used to include and/or implement the program instructions of system embodiments of the present disclosure. A bus 352 may serve as the information highway interconnecting the other illustrated components of the hardware. A processing system 354 labeled CPU (central processing unit) (e.g., one or more computer processors at a given computer or at multiple computers), may perform calculations and logic operations to execute a program. A non-transitory processor-readable storage medium, such as read only memory (ROM) 358 and random-access memory (RAM) 359, may be in communication with the processing system 354 and may include one or more programming instructions for performing the method of designing an integrated circuit. Optionally, program instructions may be stored on a non-transitory computer-readable storage medium such as a magnetic disk, optical disk, recordable memory device, flash memory, or other physical storage medium.

In FIGS. 3A, 3B, and 3C, computer readable memories 307, 330, 358, 359 or data stores 308, 332, 383, 384, 388 may include one or more data structures for storing and associating various data used in the example systems for designing an integrated circuit. For example, a data structure stored in any of the aforementioned locations may be used to store data from XML files, initial parameters, and/or data for other variables described herein. A disk controller 390 interfaces one or more optional disk drives to the system bus 352. These disk drives may be external or internal floppy disk drives such as 383, external or internal CD-ROM, CD-R, CD-RW, or DVD drives such as 384, or external or internal hard drives 385. In addition to physical drives, the system bus 352 may be in communication with cloud-based virtual drives. As indicated previously, these various disk drives and disk controllers are optional devices. In an embodiment, methods described herein may be stored as instructions in a non-transitory computer-readable medium. When the instructions are executed, one or more processors may implement the methods described herein.

Each of the element managers, real-time data buffer, conveyors, file input processor, database index shared access memory loader, reference data buffer and data managers may include a software application stored in one or more of the disk drives connected to the disk controller 390, the ROM 358 and/or the RAM 359. The processor 354 may access one or more components as required. A display interface 387 may permit information from the bus 352 to be displayed on a display 380 in audio, graphic, or alphanumeric format. Communication with external devices may optionally occur using various communication ports 382. In addition to these computer-type components, the hardware may also include data input devices, such as a keyboard 379, or other input device 381, such as a microphone, remote control, pointer, mouse and/or joystick.

Display interface 387 and interface 388 may comprise parts of a graphical user interface (GUI) that allows a user to interact with the systems through visual indicators displayed to the user via display 380. This may allow a user, for example a circuit design engineer, to engage with the system in the course of designing a circuit. Certain information pertaining to a design, such as the names and locations of particular cells or instances of cells, may be presented to a user through this GUI.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

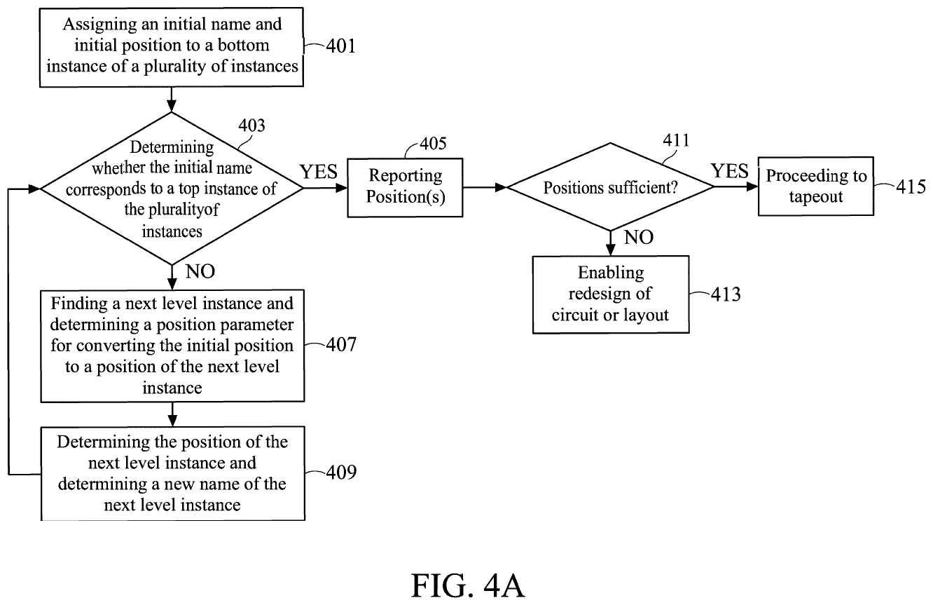

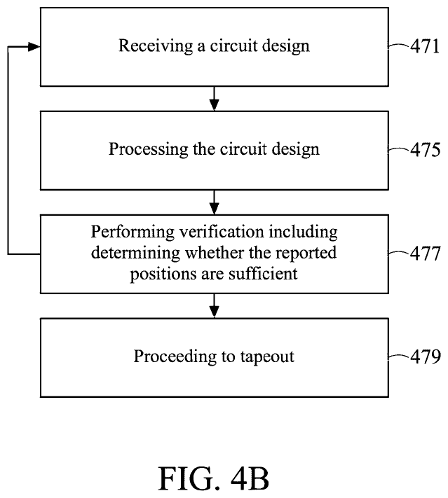

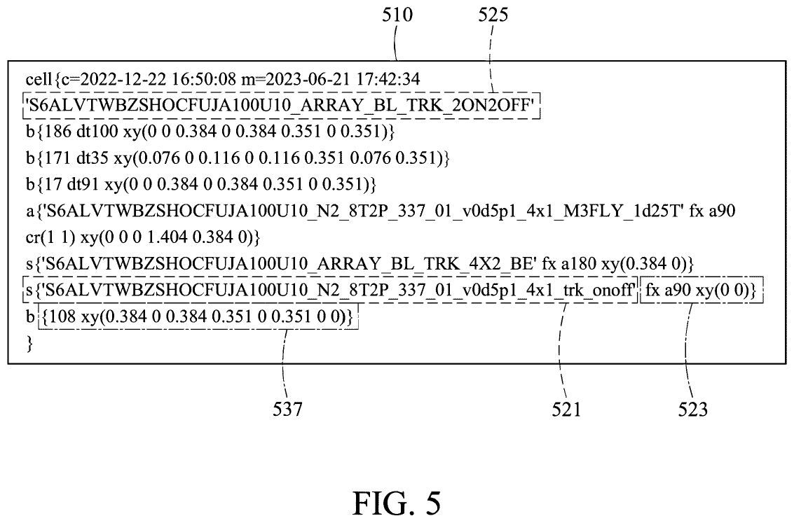

An example method of finding instances in a circuit design is described below with reference to FIG. 4A, FIG. 4B, and FIG. 5. FIG. 4A is a flowchart depicting a method of finding instances in a layout according to an embodiment. FIG. 4B is a flowchart depicting method of designing and fabricating a circuit. FIG. 5 is a conceptual diagram depicting a textual representation of circuit data according to an embodiment. Methods described herein may allow for checking a circuit design for desired instances. As such, these methods may use data from a textual representation of a circuit design, such as a gdt file as shown in FIG. 5, in order to find and identify instances.

In an embodiment, the circuit design may comprise a plurality of instances of interest. For example, FIG. 5 depicts a gdt file depicting at least two instances. The gdt file may comprise a first, “down instance” 521 present in a lower level of a layout hierarchy and a second, “up instance” 525 present in an upper level of layout hierarchy. In an embodiment, down instance 521 may be present in a bottommost, level 1 layer, and may comprise a bottom instance. Up instance 525 may be present in a level 2 layer. While not shown in FIG. 5, the layout hierarchy may comprise any number of levels. For example, the layout may comprise 7 levels, similar to the layout hierarchy depicted in FIG. 2. As described below, methods described herein may iterate through a plurality of levels so as to identify all instances of interest in each level.

Down instance 521 and up instance 525 may include one or more tracking cells. Accordingly, by identifying the presence and location of all instances similar to down instance 521, embodiments described herein may identify all tracking cells of the circuit design.

In an embodiment, the method may comprise assigning an initial name and initial position to a bottom instance of a plurality of instances at 401. The initial name may comprise a set of alphanumeric characters assigned to a particular component of the bottom instance. For example, the plurality of instances may comprise instances including one or more tracking cells and the bottom instance of the plurality of instances may represent a bottom instance of a tracking cell named “S6ALVTWBZSHOCFUJA100U10_N2_8T2P_337_01_v0d5p1_4x1_trk_onoff,” as shown in FIG. 5.

The gdt file representing the circuit design may further include data indicating a position of this instance. For example, FIG. 5 shows position data 527, which translate to coordinates of a position of down instance 521. Using the cell name and position, the method may find all other instances of the layout. More specifically, the method may use information from a lower level instance to obtain information about an instance on the next level. For example, information regarding an instance on level 1 may be used to infer the position of instances of level 2. The method may iterate through all levels of a layout in this manner until it reaches a top level at which point it may report on the positions of all instances.

This process is captured at 403, where the method may comprise determining whether the initial name corresponds to a top instance of the plurality of instances. As described above with respect to FIG. 2, while instances in different levels may share similar names, top level instances may not share this commonality. Instances in a top level may instead have a name that identifies that instance as being present in the top-level. Accordingly, at 403, the method may comprise analyzing the initial name to determine whether it is a top level name. If the name is determined to be a top level name, the method may proceed to 405 where the method comprises reporting positions of the instances. The reporting may be achieved via a graphical user interface (GUI) such that a user interacting a system may view reported positions through a display such as display 380, as depicted in FIG. 3C. However, if it is determined that the name being analyzed does not correspond to a top instance of the plurality of instances, the method may proceed through the iterative process described above.

In an embodiment, at 407 the method may comprise finding a next level instance and determining a position parameter for converting the initial position to a position of the next level instance. Returning to FIG. 5, up instance 525 may represent the next level instance in this case. The method may find this up instance using information from down instance 521. For example, the gdt file may further comprise a position parameter 523. This position parameter may comprise one or more geometric operations such as shifts, flips, rotations, translations, or the like.

For example, as shown in FIG. 5, the position parameter may be notated as “Fx a90 xy(0 0)” which may correspond to a series of three operations. Fx may indicate that the position is flipped about the x axis, a90 may indicate a 90 degree rotation in a counterclockwise direction. Generally, xy (a b) may indicate a shift by increasing x and y values by a and b respectively. In the embodiment shown in FIG. 5, however, values of a and b are set to zero indicating that the position parameter 523 does not include such a shift.

Methods described herein may use Pearl regexes to extract data such as the cell name, position information 527 and a position parameter 523 from a gdt file representing a circuit design in order to infer the position of an up instance from a down instance. For example, at 409, the method may comprise determining the new position of the next level instance and determining a new name of the next level instance.

In an embodiment, this new position may be calculated from the initial position provided by position information 527 and the position parameter 523. For example, the down instance may include a tracking cell of an SRAM as represented by a design tool for a bottom level of a layout hierarchy. When considering the next level up in the hierarchy, the position of this instance may change due to the scale of this level as compared to that of the bottom level. However, this change may be predictable, and embodiments described herein can infer the next level position from the initial position and a position parameter. The method may then comprise identifying the cell located at the next level position and determining the name of this cell.

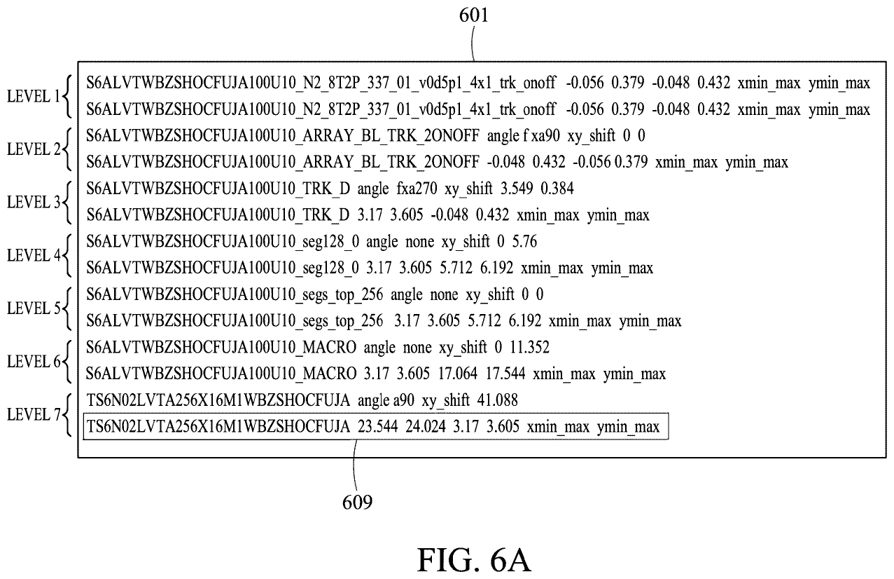

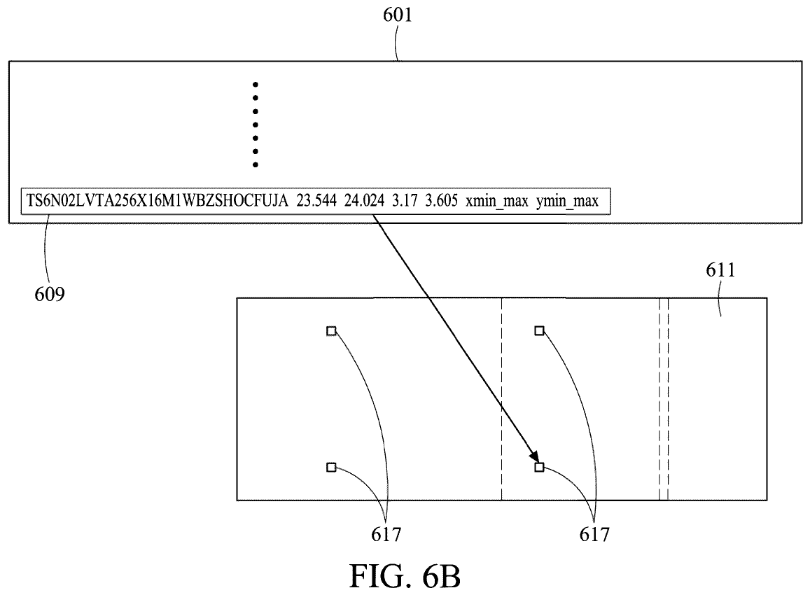

The method may then proceed back to 403 where a determination may be made as to whether this name corresponds with a top level instance. This loop can be repeated for as many levels as are present in a layout hierarchy. For example, for a layout hierarchy such as that shown in FIG. 2 having seven levels, the loop may be repeated seven times. The loop may finish when the top level instance is identified by name. The results that may be returned according to an embodiment are described below with reference to FIGS. 6A and 6B.

Upon a determination that the initial name does correspond to a top instance in 403 and reporting of positions in 405, a determination may be made at 411 as to whether the positions meet certain predetermined criteria or design rules. For example, methods described herein may seek to determine whether there is a sufficient placement, sufficient spacing, sufficient number, sufficient density, or other property of a particular instance. In an embodiment, an instance may comprise one or more tracking cells and the reporting of positions in 405 may provide information on the placement, number, density, or other property or characteristics of tracking cells in the layout. This information may be used to determine whether the design or layout satisfies certain predetermined criteria or design rules. For example, the design may call for a certain number of tracking cells, or density of tracking cells, or require the tracking cells to be in a certain location or have a certain spacing.

The reported positions may be compared against these desired values to determine whether the design satisfies the rules and therefore passes verification. In some embodiments, this process may be automated and the method may involve alerting a user as to whether or not the positions are sufficient via a GUI. In other embodiments, the positions may be reported to a user via the GUI and the user may make a determination as to whether or not the positions are sufficient.

In an embodiment, if the positions are deemed sufficient, the method may proceed to tapeout at 415. In this process, the method may enable an integrated circuit to be fabricated based on the layout. The tapeout process may involve additional design processes, including final simulation, verification, and design rule checks before ultimately resulting in fabrication of a circuit based on the layout. As described above the method may comprise determining the sufficiency of the reported positions. In an embodiment where it is determined that the reported are sufficient, the method may then translate the layout into a form or format that may be used to fabricate an integrated circuit based on the layout.

In an embodiment, if the positions are deemed insufficient, the method may proceed to 413 and enable redesign of the circuit or layout. For example, the method may comprise reporting to a user, via a GUI, that the positions of the tracked instances fail to meet certain predetermined criteria or design rules and enabling the user to initiate a redesign to fix this issue. Accordingly, this process may ensure that the tracked instances or components thereof such as a plurality of tracking cells meet all predetermined criteria or design rules before proceeding to tapeout. This process is described in greater detail below, with reference to FIG. 4B.

FIG. 4B is a flowchart depicting method of designing and fabricating a circuit. The method may begin at 471 by receiving a circuit design. This circuit design may be input by a user or may comprise predetermined layouts that a user may be able to edit or alter to fit a particular desired function. At 475, the method proceeds to process the circuit design. This processing may comprise a number of steps that transform an input design from the conceptual level to a verifiable design. For example, the process at 475 may comprise steps such as floorplanning, placement, clock tree synthesis, routing, and generating a layout. Additionally, the processing at 475 may comprise one or more simulations or testing processes to optimize the design. Further one or more engineering change orders (ECO) may be implemented during processing at 475.

The method may then proceed to verification at 477. In this process the method may comprise performing verification of a layout generated during processing of the circuit design. Performing verification may comprise finding instances within a layout as described in reference to FIG. 4A, for example. Accordingly, the reporting of positions at 405 of FIG. 4A, for example, may be part of a verification process to determine the viability of a circuit design before proceeding to tapeout. In an embodiment, the instances comprise one or more tracking cells and embodiments described herein may be used to determine whether there is a sufficient number, placement, spacing, density, or other characteristic of tracking cells in a circuit design or layout. The method may further comprise, at 479, proceeding to tapeout. The tapeout process may be similar to that described above with reference to FIG. 4A.

FIGS. 6A and 6B are conceptual diagrams depicting example results of a method of finding instances in a circuit diagram according to an embodiment. FIG. 6A depicts a first example window 601 of GUI displaying example results, and FIG. 6B depicts a second example window 611 of a GUI displaying example results. 601 and 611 are depictions of windows displaying example results of a method as described with respect to FIGS. 4 and 5, as provided to a user of a circuit design tool through a GUI. In some embodiments, the methods described herein may comprise a computer-implemented function or computer-implemented program run on a circuit design tool. The results of such a method may be output to a user of the circuit design tool so as to inform the user of the identified instances and their locations.

In an embodiment, the results may be output to a user in textual form as shown in window 601. This window may show instances identified in all levels of a layout hierarchy and provide positions thereof. Box 609 shows that an example method as described above may identify an instance on a top level, level 7, of a layout hierarchy from bottom level information.

However, in some embodiments, while only one instance may be found in a top level, each instance may have multiple occurrences or contain multiple tracking cells. In FIG. 6B, for example, window 611 shows a layout view of the circuit design corresponding to the textual representation shown in FIG. 6A. As shown in FIG. 6B, while there may only be one instance identified in level 7, this instance may comprise four tracking cells 617.

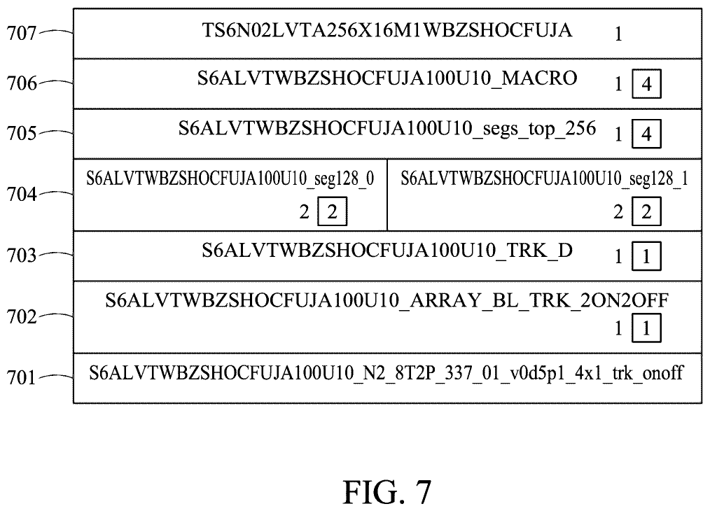

The number of target cells, or otherwise targeted small instances, within an identified instance may represent number information that can be used to provide additional details when searching for and finding instances within a circuit design. The use of number information to show all possible appearances of a particular small instance is described in greater detail below with reference to FIGS. 7-9.

FIG. 7 is a conceptual diagram depicting a layout hierarchy according to an embodiment. The layout hierarchy of FIG. 7 may be similar to the layout hierarchy described above with respect to FIG. 2 and may comprise seven levels. For example, the hierarchy may comprise a bottom level 701, a second level 702, a third level 703, a fourth level 704, a fifth level 705, a sixth level 706, and a seventh, top level 707. Using methods described herein, instances in upper levels may be inferred from information relating to bottom instance in first level 701.

FIG. 7 differs from FIG. 2, in that number information for each upper level is also shown. For example, the boxed number in each level may represent number information for that level, meaning the number of cells in each identified instance. More specifically, FIG. 7 depicts two numbers for each upper level—the number not within a box may represent the number of instances identified in that level, while the boxed number represents the number of cells in each instance. In an embodiment, the method may be concerned with identifying all tracking cells of a circuit design and the boxed numbers may represent the number of tracking cells in each instance for each level.

In greater detail, bottom level 701 may comprise a representation of the smallest building blocks for a circuit design. In an embodiment, bottom level 701 may represent individual cells and may identify an individual tracking cell. From information provided in a gdt file for the circuit design, instances of the tracking cell may be identified in higher levels. In second level 702, there may be one instance identified and that instance may comprise a single tracking cell. Similarly, in third level 703, there may be one instance identified comprising a single tracking cell.

However, in fourth level 704, which may be represent the circuit design at a segment level and may be sub-divided into two segments, there may be instances identified in each segment and each segment may comprise two tracking cells.

In fifth level 705, which may represent the circuit at a level higher than the segment level, there may be only one identified instance. But this instance may comprise four tracking cells. This number represents the two tracking cells from a first segment of the fourth level and two tracking cells from the second segment of the fourth level. Similarly, sixth level 706 and top level 707 each may comprise one instance, but these instances include four tracking cells. This number information may be represented mathematically so as to allow methods described herein to incorporate the number information into methods for finding instances in order to find all target cells or other small instance within a layout.

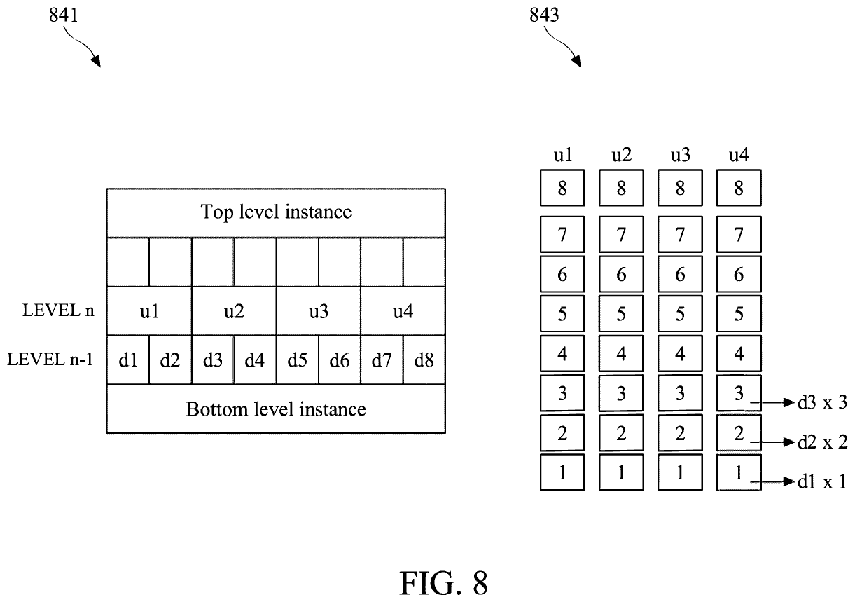

FIG. 8 is a conceptual diagram depicting number information represented as a 2D array according to an embodiment. The number information of a layout hierarchy can be represented as a 2D array wherein the array has a size of Kₙ₋₁ x Kₙ, where Kₙ refers to a number of instances at the nth level and Kₙ₋₁ refers to a number of instances at the (n-1)th level. For example, a sample layout hierarchy 841 is shown in which there are four instances in the nth level (u1, u2, u3, and u4) and eight instances in the (n-1)th level (d1, d2, d3, d4, d5, d6, d7, and d8). Accordingly, the number information of the nth layer may be represented as a 4×8 array. An example array 843 is shown, wherein each of u1 to u4 may be represented as a 1×8 array and combined to form a 4×8 array representing the nth level. The number information, represented as a 2d array may allow the program to find and locate all instances in a layout by ensuring that the number of instances in each level is accurately represented and accounted for during an instance finding process. However, as described below, embodiments are not so limited and the number information may instead be represented as a 3D network.

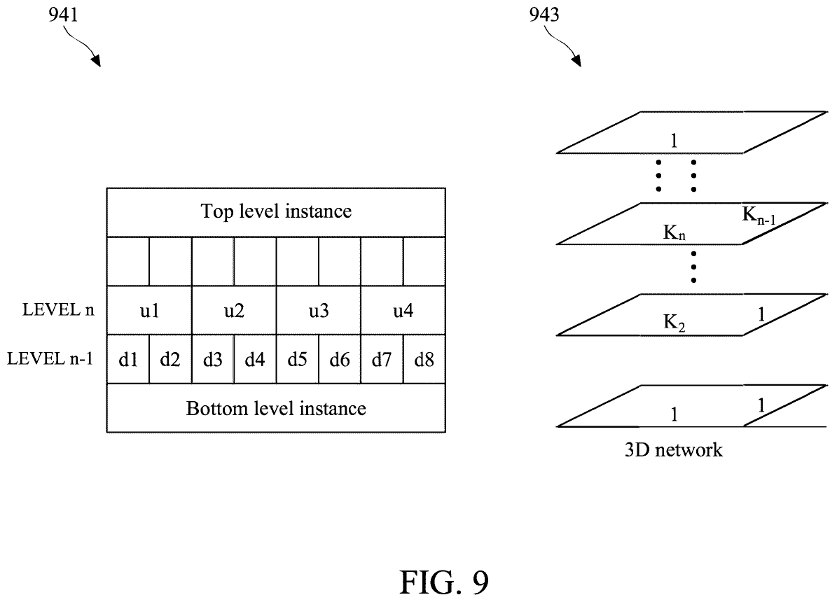

FIG. 9 is a conceptual diagram depicting number information represented as a 3D network according to an embodiment. Similar to the embodiment described above with respect to a 2D array, the representation of number information as a 3D network may depend on the number of instances on each level. For example, number information of layout hierarchy 941 may be represented as 3D network 943. In each level of the layout hierarchy, the makeup of the 3D network may depend on the number of instances in that level. In levels between a top and bottom level, the 3D network representation may depend upon the number of instances in that level and a number of instances in the preceding level.

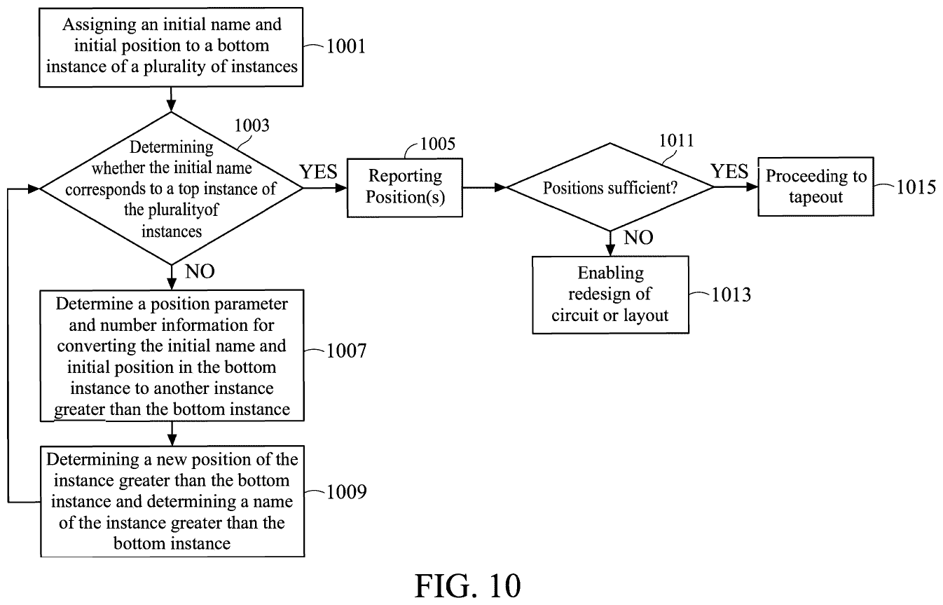

Accordingly, where layout 941 comprises four instances in the nth level and eight instances in the (n-1)th level, the 3D network 943 may reflect that as a level comprising four (Kₙ) row components and eight column components (Kₙ₋₁). Modeling the number information as a 3D network may allow methods described herein to ensure that all instances in each level are accurately represented and accounted for during an instance finding process. Embodiments using number information are described in greater detail below with references to FIGS. 10-12.

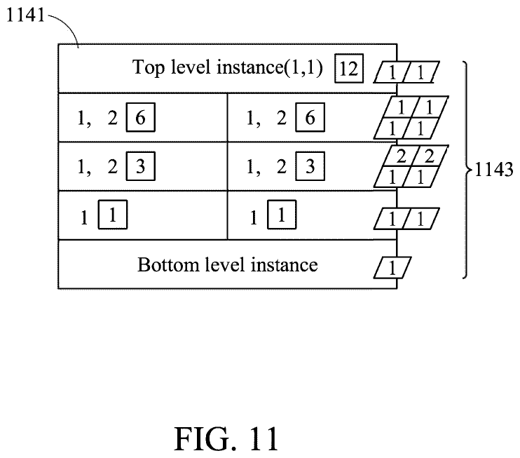

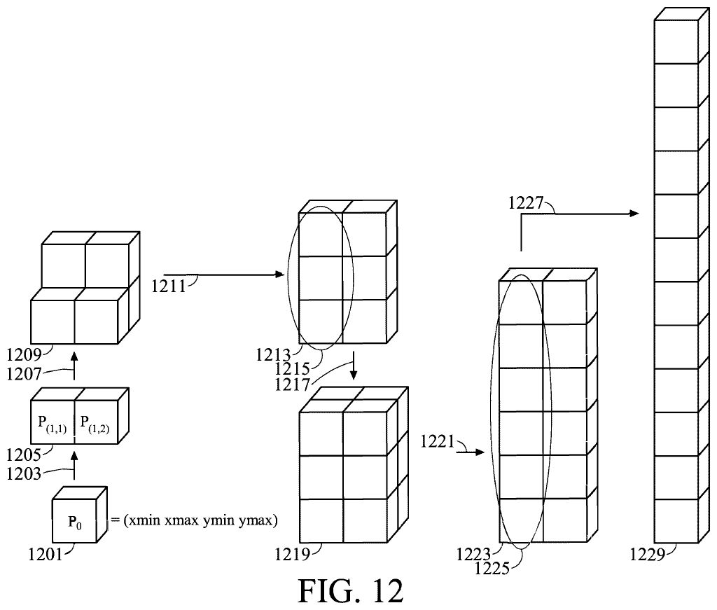

FIG. 10 is a flowchart depicting a method of finding instances in a layout according to an embodiment. FIG. 11 is a conceptual diagram depicting number information according to an embodiment. FIG. 12 is a schematic diagram depicting a method of finding instances using number information according to an embodiment.

In an embodiment a method of finding instances in a layout may comprise, at 1001, assigning an initial name and initial position to a bottom instance of a plurality of instances. As described above with reference to FIG. 4, the name and position may be assigned and provided in a text file, such as a gdt file. For example, the method may provide a means for finding tracking cells of a layout and the initial name may comprise the name of a tracking cell in a bottom level instance. Embodiments described herein may extract the name and position information from this gdt file in order to find other instances within the layout. In an embodiment, the method may use Pearl regexes to extract this information.

For example, the layout may be represented by layout hierarchy 1141 as shown in FIG. 11. Layout hierarchy may comprise number information, indicated by the boxed numbers of the layout, that can be used to identify and locate all instances within the layout. This number information may be represented by 3D network 1143. FIG. 12 shows a schematic representation of the development of such a 3D network through the course of the process of FIG. 10.

At 1001, an initial name and initial position may be assigned to a bottom instance. This may correspond to the bottom level instance of FIG. 11, and may be represented as a single block 1201 in FIG. 12. As shown in FIG. 12, the initial position may be defined by four coordinates (xₘᵢₙ, xₘₐₓ, yₘᵢₙ, yₘₐₓ), which may correspond to a representation of a circuit design by a circuit design tool and presented via a GUI to a user.

The method may further comprise, at 1003, determining whether the initial name corresponds to a top instance of the plurality of instances. As described above with respect to FIGS. 2 and 7, while instances in different levels may share similar names, top level instances may not share this commonality. Instances in a top level may instead have a name that identifies that instance as being present in the top-level. Accordingly, at 1003, the method may comprise analyzing the initial name to determine whether it is a top level name. If the name is determined to be a top level name, the method may proceed to 1005 where the method comprises reporting positions of the instances.

However, if it is determined that the name being analyzed does not correspond to a top instance of the plurality of instances, the method may proceed to 1007 where it may comprise determining a position parameter and number information for converting the initial name and initial position in the bottom instance to another instance greater than the bottom instance.

As described above with respect to FIGS. 4 and 5, a position parameter may comprise a geometric operation such as a flip, translation, rotation, or the like that may indicate the position of similar instances in the layout. The position parameter may be extracted or inferred from a gdt file. The number information may also be extracted from the gdt file. However, embodiments herein are not so limited and the number information may be determined by other means.

The method may then proceed to 1009 and may comprise determining a new position of the instance greater than the bottom instance and determining a name of the instance greater than the bottom instance.

Referring again to FIG. 11, the second level may comprise two instances and each instance may comprise one tracking cell. Accordingly to obtain the locations of these instances, the method may use the initial position and apply a position parameter. This may be represented by arrow 1203 in FIG. 12. Additionally, the method may determine, based on number information, that there are multiple instances in the second level. Accordingly, the second level instances may be represented by the 3D network shown at 1205 of FIG. 12. In some embodiments, different position parameters may be identified and used to find multiple upper level instances from a single lower level instance. For example, a different position parameter may be used to find p_{1,1} of 1205 from p₀ of 1201 than is used to find p_{1,2} of 1205.

At 1009, the method may also determine a name (or names) for the instance(s) greater than the bottom instance. Once this name has been determined, the method may proceed back to 1003 and a determination may be made as to whether this name corresponds to a top instance of the plurality of instances. As described above, this process may iterate through each level of a layout hierarchy until reaching a top level. For example, the layout of FIG. 11 may loop through the process four times at which point the method may recognize that the name of the fifth level instance corresponds with a top level instance and proceed to 1005 to report positions.

Upon a determination that the initial name does correspond to a top instance in 1003 and reporting of positions in 1005, a determination may be made at 1011 as to whether the positions meet certain predetermined criteria or design rules. For example, methods described herein may seek to determine whether there is a sufficient placement, sufficient spacing, sufficient number, sufficient density, or other property of a particular instance. In an embodiment, an instance may comprise one or more tracking cells and the reporting of positions in 1005 may provide information on the placement, number, density, or other property or characteristics of tracking cells in the layout. This information may be used to determine whether the design or layout satisfies certain predetermined criteria or design rules. For example, the design may call for a certain number of tracking cells, or density of tracking cells, or require the tracking cells to be in a certain position or have a certain spacing.

The reported positions may be compared against these desired values to determine whether the design satisfies the rules and therefore passes verification. In some embodiments, this process may be automated and the method may involve alerting a user as to whether or not the positions are sufficient via a GUI. In other embodiments, the positions may be reported to a user via the GUI and the user may make a determination as to whether or not the positions are sufficient.

In an embodiment, if the positions are deemed sufficient, the method may proceed to tapeout at 1015. In this process, the method may enable an integrated circuit to be fabricated based on the layout. The tapeout process may involve additional design processes, including final simulation, verification, and design rule checks before ultimately resulting in fabrication of a circuit based on the layout. As described above the method may comprise determining the sufficiency of the reported positions. In an embodiment where it is determined that the reported are sufficient, the method may then translate the layout into a form or format that may be used to fabricate an integrated circuit based on the layout.

In an embodiment, if the positions are deemed insufficient, the method may proceed to 1013 and enable redesign of the circuit or layout. For example, the method may comprise reporting to a user, via a GUI, that the positions of the tracked instances fail to meet certain predetermined criteria or design rules and enabling the user to initiate a redesign to fix this issue. Accordingly, this process may ensure that the tracked instances or components thereof such as a plurality of tracking cells meet all predetermined criteria or design rules before proceeding to tapeout. This process may be similar to that described above with reference to FIG. 4B.

As described above, in some embodiments, methods may iterate through layers of a layout before reaching a top instance. Such iterations are described in greater detail below with respect to FIG. 12. As described above, a first loop may result in a second level representation of number information 1205. Upon a next loop, the process may use another position parameter to convert second level representation to a third level representation 1209. Then, at 1211, number information indicating that each instance in the third level comprises three tracking cells (indicated by the three blocks within oval 1215) may be used to generate another third level representation 1213. Upon an additional loop, the process may use another position parameter to convert from representation 1213 to a fourth level representation 1219. At 1221, number information indicating that each instance in the fourth may comprise six tracking cells (indicated by the six blocks within oval 1225) may be used to generate another fourth level representation 1223. Upon one more loop, at 1227 the process may use another position parameter to convert from the fourth level representation 1223 to fifth, and top, level representation 1229. This final level representation indicates that there are twelve tracking cells in the top level instance. In an embodiment, the positions of these tracking cells may be a final output of the process.

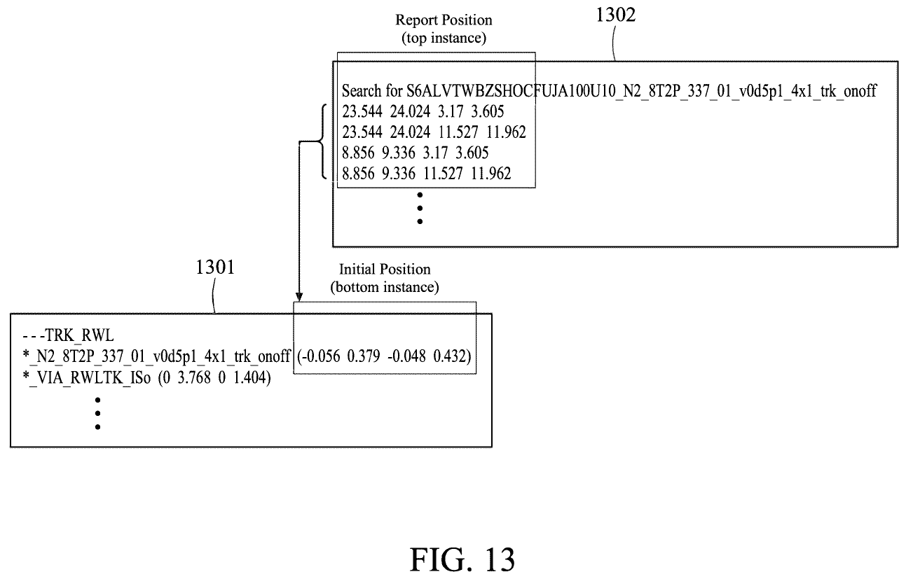

FIG. 13 is a conceptual diagram depicting example results of a method of finding instances in a circuit diagram according to an embodiment. As described above, the initial input of embodiments described herein may comprise an initial position of a bottom instance as shown at 1301. The final output may be a report of positions of tracking cells within a top instance as shown at 1302. This report may be generated by systems and methods described herein and may be output to a user through a GUI as shown at 1302. In doing so, embodiments described herein may provide an automated process for determining the location of all instances of a tracking cell within a layout.

Systems and methods are described herein. An example of method finding instances in a layout includes assigning an initial name and an initial position of a tracking cell in a bottom instance of a plurality of instances, determining whether the initial name corresponds to a name of a top instance of the plurality of instances, determining a position parameter and a number information for converting the initial name and the initial position in the bottom instance to another instance greater than the bottom instance, and reporting the position of the instance greater than the bottom instance to a user, via a graphical user interface (GUI), wherein an integrated circuit is fabricated based on the circuit layout.

Another example method may be stored as instructions in a non-transitory computer readable medium. When executed by a processor, the instructions cause the processor to assign an initial name and an initial position to a bottom instance of a plurality of instances, determine whether the initial name corresponds to a top instance of the plurality of instances, find a next level instance and determining a position parameter for converting the initial position to a position of the next level instance, and determine the position of the next level instance and determining a next level instance name. The instructions also cause the processor to determine whether the next level instance name corresponds to the top instance of the plurality of instances and report a position of the next level instance to a user via a graphical user interface (GUI).

A system for finding tracking cells in a layout of a memory circuit design is provided. The system comprises one or more processors and a non-transitory computer readable medium having instructions stored thereon that, when executed by a processor, cause the one or more processors to perform operations. The operations comprise assigning an initial name and an initial position of a tracking cell in a bottom instance of a plurality of instances, determining whether the initial name corresponds to a name of a top instance of the plurality of instances, and determining a position parameter and a number information for converting the initial name and the initial position in the bottom instance to another instance greater than the bottom instance. The system enables a circuit to be fabricated based on the layout.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A processor-implemented method of finding instances in a circuit layout, comprising:
assigning an initial name and an initial position to a tracking cell in a bottom instance of a plurality of instances;
determining whether the initial name corresponds to a name of a top instance of the plurality of instances;
determining a position parameter and a number information for converting the initial name and the initial position in the bottom instance to another instance greater than the bottom instance; and
reporting the position of the instance greater than the bottom instance to a user, via a graphical user interface (GUI),
wherein an integrated circuit is fabricated based on the circuit layout.

2. The method of claim 1, wherein the position parameter comprises a flip operation, a rotating operation and a shifting operation;
the converting comprises applying the position parameter to the initial position;
representing the number information as a 2D array or a 3D network; and
applying the number information to determine the presence of more than one instance greater than the bottom instance.

3. The method of claim 1, wherein the number information comprises a number of tracking cells of each instance of the plurality of instances.

4. The method of claim 3, wherein the number information is represented as a 3D network.

5. The method of claim 1, wherein the circuit comprises one or more memory macros; and
the tracking cell is disposed in a memory segment of a first macro of the one or more memory macros.

6. The method of claim 1, further comprising determining a new position of the instance greater than the bottom instance and a name of the instance greater than the bottom instance.

7. The method of claim 6, further comprising determining that the name of the instance greater than the bottom instance corresponds to the top instance of the plurality of instances.

8. The method of claim 7, further comprising determining whether the reported positions are sufficient; and
enabling redesign of the circuit layer.

9. The method of claim 1, wherein the layout comprises one or more memory macros.

10. The method of claim 1, wherein the instance greater than the bottom instance comprises a plurality of tracking cells.

11. A non-transitory computer readable medium having instructions stored thereon that, when executed by a processor, cause the processor to perform operations comprising:
assigning an initial name and an initial position to a bottom instance of a plurality of instances;
determining whether the initial name corresponds to a top instance of the plurality of instances;
finding a next level instance and determining a position parameter for converting the initial position to a position of the next level instance; and
determining the position of the next level instance and determining a next level instance name;
determining whether the next level instance name corresponds to the top instance of the plurality of instances; and
reporting a position of the next level instance to a user via a graphical user interface (GUI).

12. The non-transitory computer readable medium of claim 11, wherein the operations further comprise:
determining whether the position satisfies one or more design rules.

13. The non-transitory computer readable medium of claim 11, wherein the one or more design rules comprise a number of or density of the next level instance.

14. The non-transitory computer readable medium of claim 11, wherein the operations further comprise enabling a redesign of an integrated circuit based on the position.

15. The non-transitory computer readable medium of claim 11, wherein the plurality of instances each comprise one or more tracking cells.

16. The non-transitory computer readable medium of claim 11, wherein the initial name and initial position are extracted from a text file.

17. A system for finding tracking cells in a layout of a memory circuit design comprising:
one or more processors; and
a non-transitory computer readable medium having instructions stored thereon that, when executed by a processor, cause the one or more processors to perform operations comprising:
assigning an initial name and an initial position of a tracking cell in a bottom instance of a plurality of instances;
determining whether the initial name corresponds to a name of a top instance of the plurality of instances;
determining a position parameter and a number information for converting the initial name and the initial position in the bottom instance to another instance greater than the bottom instance;
determining a new position of the instance greater than the bottom instance and a name of the instance greater than the bottom instance;
determining whether the name of the instance greater than the bottom instance corresponds to the top instance of the plurality of instances; and
enabling an integrated circuit to be fabricated based on the layout.

18. The system of claim 17, wherein the operations further comprise determining a position of all tracking cells within a top level of a layout hierarchy representing the circuit design.

19. The system of claim 17, wherein the number information is represented by a 2D array or a 3D network.

20. The system of claim 19, wherein the converting comprises applying one or more of a flip operation, rotate operation, or shift operation, to the initial position based on the position parameter.
